(19) United States
(12) Patent Application Publication
(10) Pub. No.: US 2013/0019209 A1
(43) Pub. Date: Jan. 17, 2013

(54) IMAGE PROCESSING APPARATUS, IMAGE PROCESSING METHOD, AND STORAGE MEDIUM STORING PROGRAM

(71) Applicants: Yoshikazu Ishikawa, Kawasaki-shi (JP); Satoshi Ishimaru, Kawasaki-shi (JP); Souichirou Shigeeda, Yokohama-shi (JP)

(72) Inventors: Yoshikazu Ishikawa, Kawasaki-shi (JP); Satoshi Ishimaru, Kawasaki-shi (JP); Souichirou Shigeeda, Yokohama-shi (JP)

(73) Assignee: CANON KABUSHIKI KAISHA, Tokyo (JP)

(21) Appl. No.: 13/525,646

(22) Filed: Jun. 18, 2012

(30) Foreign Application Priority Data
Jun. 23, 2011 (JP) 2011-139628

(51) Int. Cl. G06F 3/048

(52) U.S. Cl. 715/838

(57) ABSTRACT

An image processing apparatus acquires from a moving image, frames captured at predetermined time intervals or at positions of predetermined intervals with respect to a direction of gravity, and generates thumbnail images. The image processing apparatus then displays the thumbnail images in a display area at positions corresponding to the water depths at which the frames corresponding to the generated thumbnail images were captured.

### BACKGROUND OF THE INVENTION

1. Field of the Invention

The present invention relates to an image processing apparatus, an image processing method, and a storage medium storing a program appropriate for displaying thumbnail images corresponding to frames constituting a moving image.

2. Description of the Related Art

Conventionally, there is a technique for an imaging apparatus to record image data together with positioning information indicating a position and an altitude at which an image is captured. The imaging apparatus then displays the image on a map based on the positioning information (as in Japanese Laid-Open Patent Application No. 2006-157810).

However, according to the conventional technique, if the position and the altitude of each of the images are close to each other, such as when performing continuous shooting, the images are displayed as overlapping images and thus become difficult to view. In particular, if a moving image is to be captured underwater, the images are often captured within a small area over a long period of time, so that shooting positions cannot be appropriately expressed.

### SUMMARY OF THE INVENTION

The present invention provides an image processing apparatus comprising a generation unit configured to generate thumbnail images from frames included in a moving image and a display unit configured to arrange and display the thumbnail images based on shooting time and shooting position, with respect to a direction of gravity, of the frames corresponding to the thumbnail images, wherein the generation unit generates the thumbnail images from the frames captured at each of a plurality of predetermined levels in the direction of gravity.

One aspect of the present invention is directed to appropriately expressing, if the imaging apparatus moves with respect to a direction of gravity while capturing the moving image, the shooting position with respect to the direction of gravity of a scene in the moving image. A user can thus easily recognize the shooting position.

Further features of the present invention will become apparent from the following description of exemplary embodiments (with reference to the attached drawings).

### BRIEF DESCRIPTION OF THE DRAWINGS

FIG. 1 is a block diagram illustrating an example configuration of an imaging apparatus according to an exemplary embodiment of the present invention.

FIG. 2 is a flowchart illustrating an example process for recording moving image data performed by an imaging apparatus according to an exemplary embodiment of the present invention.

FIG. 3 is a flowchart illustrating another example process for displaying the moving image performed by an imaging apparatus according to an exemplary embodiment of the present invention.

FIGS. 4A, 4B, and 4C illustrate examples of screens according to an exemplary embodiment of the present invention.

FIGS. 5A and 5B illustrate examples of an arrangement of images on a screen according to an exemplary embodiment of the present invention.

FIG. 6 is a flowchart illustrating an example process performed by an imaging apparatus according to an exemplary embodiment of the present invention.

FIG. 7 illustrates an example of a screen according to an exemplary embodiment of the present invention.

FIG. 8 is a flowchart illustrating an example process performed by an imaging apparatus according to an exemplary embodiment of the present invention.

FIG. 9 illustrates an example of a screen according to an exemplary embodiment of the present invention.

FIGS. 10A and 10B illustrate examples of metadata according to an exemplary embodiment of the present invention.

FIG. 11 is a flowchart illustrating an example process performed by an imaging apparatus according to an exemplary embodiment of the present invention.

FIG. 12 is a flowchart illustrating another example process performed by an imaging apparatus according to an exemplary embodiment of the present invention.

FIGS. 13A and 13B illustrate examples of screens according to an exemplary embodiment of the present invention.

FIG. 14 is a flowchart illustrating an example process performed by an imaging apparatus according to an exemplary embodiment of the present invention.

FIG. 15 is a flowchart illustrating another example process performed by an imaging apparatus according to an exemplary embodiment of the present invention.

FIG. 16 is a flowchart illustrating yet another example process performed by an imaging apparatus according to an exemplary embodiment of the present invention.

### DESCRIPTION OF THE EMBODIMENTS

The accompanying drawings, which are incorporated in and constitute a part of the specification, illustrate exemplary embodiments, features, and aspects of the invention and, together with the description, serve to explain the principles of the invention.

In the exemplary embodiments of the present invention to be described below, the moving image captured underwater is an example of the images captured at different altitudes.

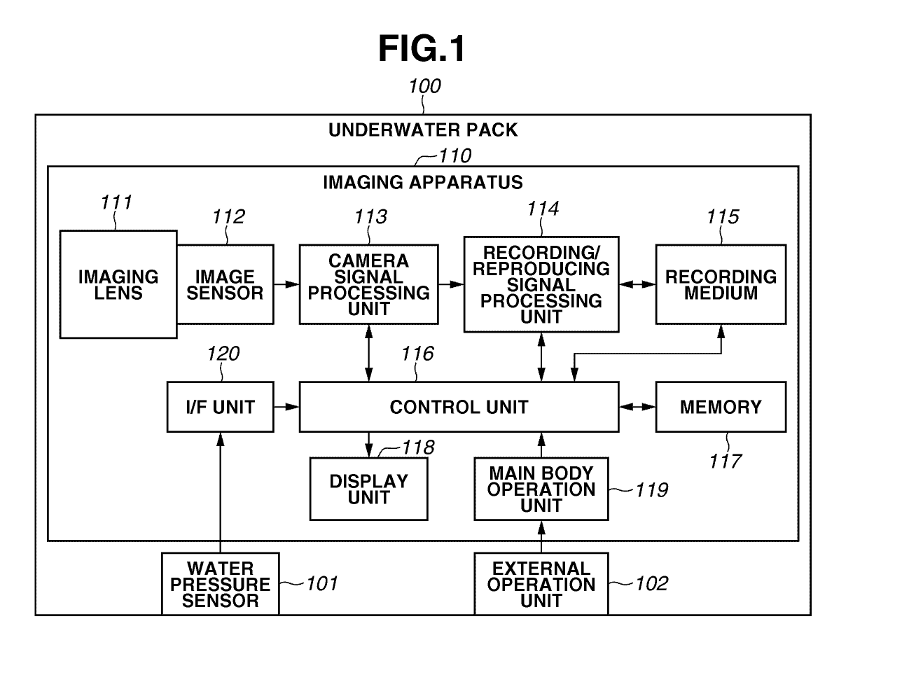

FIG. 1 is a block diagram illustrating a configuration example of an imaging apparatus 110 according to a first exemplary embodiment. The imaging apparatus 110 includes an image displaying device and an underwater pack which enables underwater image capturing. In the first exemplary embodiment, a video camera which captures the moving images will be described as an example of the image processing apparatus.

Referring to FIG. 1, a waterproof underwater pack 100 is attached to the outside of the imaging apparatus 110, so that the imaging apparatus 110 becomes capable of capturing the images underwater. An imaging lens 111 is configured to capture an object image. An image sensor 112 such as a complementary metal-oxide semiconductor (CMOS) converts the object image formed by the imaging lens 111 to an electric signal.

A camera signal processing unit 113 performs predetermined signal processing on the electric signal output from the image sensor 112 and outputs the result as a camera signal. A recording/reproducing signal processing unit 114 performs predetermined signal processing, such as a compression process, on the camera signal output from the camera signal processing unit 113. The recording/reproducing signal processing unit 114 then records the processed signal as image data in a recording medium 115 such as a memory card. Further, when the imaging apparatus 110 is in a playback mode, the recording/reproducing signal processing unit 114 reproduces the image data recorded in the recording medium 115.

A control unit 116 is a microcomputer for controlling the imaging apparatus 110. A memory 117 stores parameters of the imaging apparatus 110, which is controlled by the control unit 116. A display unit 118 displays, when the control unit 116 functions as a display control unit, a through image in a shooting mode, a reproduced image in the playback mode, and icons and text as a user interface. A main body operation unit 119 which functions as an instruction unit is an operation unit for the user to instruct the imaging apparatus 110 to perform operations. An interface unit 120 mediates information input to the imaging apparatus 110 from outside.

A configuration example of the underwater pack 100 will be described below. The underwater pack 100 includes a water pressure sensor 101 and an external operation unit 102. The water pressure sensor 101 detects water pressure. The external operation unit 102 is an operation unit used by the user to instruct via the underwater pack 100, the imaging apparatus 110 inside the underwater pack 100 to perform the operations.

The operation of the imaging apparatus 110 according to an exemplary embodiment will be described below.

The image sensor 112 performs photoelectric conversion of the object image formed by the imaging lens 111, and the result is output to the camera signal processing unit 113 as the electric signal. The camera signal processing unit 113 then performs predetermined signal processing, such as gamma correction and white balance processing, on the electric signal output from the image sensor 112. The camera signal processing unit 113 outputs the processed result to the recording/reproducing signal processing unit 114 as the camera signal. The memory 117 stores the parameters used by the camera signal processing unit 113 for performing predetermined signal processing. The control unit 116 thus controls the camera signal processing unit 113 to appropriately perform signal processing according to the parameters stored in the memory 117.

The recording/reproducing signal processing unit 114 then performs predetermined signal processing, such as setting a recording size in a recording mode, on the camera signal output from the camera signal processing unit 113. As a result, the recording/reproducing signal processing unit 114 acquires frames, and outputs the frames as moving image data to the recording medium 115. Further, the recording/reproducing signal processing unit 114 outputs the moving image data to be displayed as the through image to the control unit 116. The recording medium 115 thus records as the moving image data, the signal processed by the recording/reproducing signal processing unit 114. The control unit 116 outputs the moving image data output from the recording/reproducing signal processing unit 114 to the display unit 118. The display unit 118 thus functions as a monitor when the imaging apparatus 110 is capturing the moving images. At the same time, the display unit 118 displays the through image, an operation mode and a shooting time of the imaging apparatus 110, which are related to the user interface. The above-described series of operations are performed by the user operating the main body operation unit 119 in the imaging apparatus 110.

The shooting operation performed when the underwater pack 100 is attached to the imaging apparatus 110 will be described below.

As described above, the underwater pack 100 includes the external operation unit 102, and the user performs the shooting operation and a playback operation of the imaging apparatus 110 from outside the underwater pack 100. For example, if the user operates a zoom lever (not illustrated) in the external operation unit 102, a member (not illustrated) coupled with a zoom key in the imaging apparatus 110 inside the underwater pack 100 operates the zoom key. The user can thus change a shooting angle.

Further, as described above, the underwater pack 100 includes the water pressure sensor 101 which detects the water pressure. The imaging apparatus 110 is thus capable of acquiring via the interface unit 120 the water pressure, i.e., water pressure information, detected by the water pressure sensor 101. More specifically, since the interface unit 120 in the imaging apparatus 110 is a jack connector, the water pressure sensor 101 is connectable by inserting a wire plug i.e., an output line, thereof into the interface unit 120. The connection between the imaging apparatus 110 and the water pressure sensor 101 is not limited to the wire plug. Other methods, such as wireless communication and short range wireless communication, may be employed in performing connection, as long as the signals can be transmitted and received. According to an exemplary embodiment, the underwater pack 100 includes the water pressure sensor 101. However, a similar operation may be realized in the case where the water pressure sensor 101 is installed in the main body of the imaging apparatus 110.

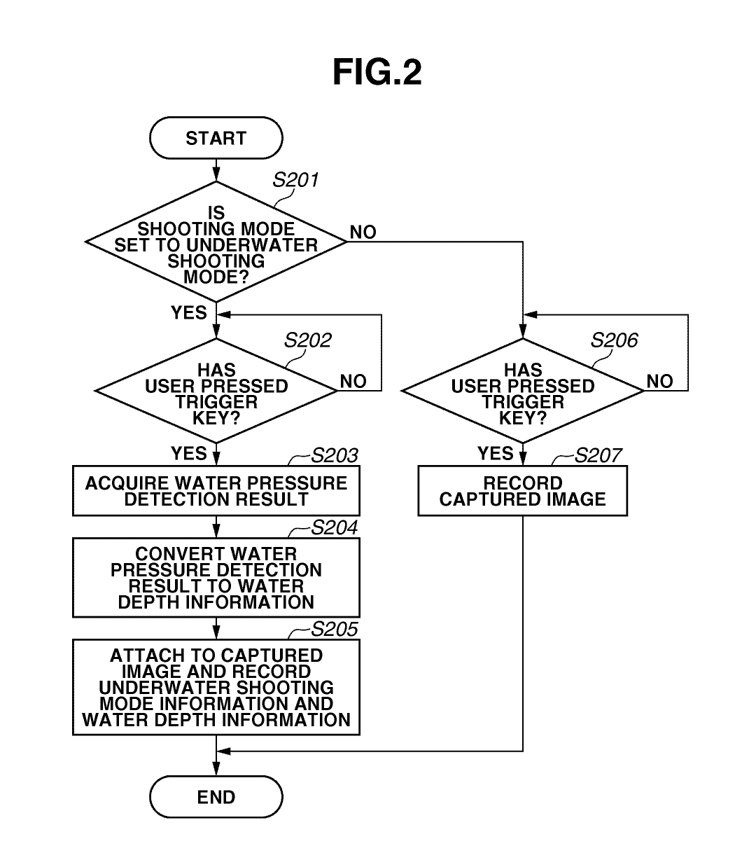

The process in which the imaging apparatus 110 converts the water pressure information acquired from the water pressure sensor 101 to water depth information, and records the moving image data by attaching the water depth information as metadata will be described below with reference to the flowchart illustrated in FIG. 2. FIG. 2 illustrates an example recording process performed when the imaging apparatus 110 captures the images according to an exemplary embodiment. The control unit 116 performs each of the processes illustrated in FIG. 2 at every vertical synchronous cycle.

When the user switches the imaging apparatus 110 to the shooting mode, the process starts. In step S201, the control unit 116 determines whether the current shooting mode is an underwater shooting mode. Since, unlike in the air, an infrared component of sunlight is absorbed underwater, it becomes important to control white balance of the imaging apparatus 110 appropriately to capture the images underwater. As a result, the control unit 116 determines whether the user has set the imaging apparatus 110 to the underwater shooting mode before capturing images underwater. If the underwater shooting mode is set (YES in step S201), the process proceeds to step S202. If the underwater shooting mode is not set (NO in step S201), the process proceeds to step S206.

In step S202, the control unit 116 stands by until detecting that the user has pressed a trigger key, for example a shooting start key, in the imaging apparatus 110. If the control unit 116 detects that the user has pressed the trigger key (YES in step S202), the process proceeds to step S203. In step S203, the control unit 116 acquires via the interface unit 120, the water pressure detected by the water pressure sensor 101 as the water pressure information.

In step S204, the control unit 116 functions as an acquisition unit, and converts the water pressure information acquired in step S203 to the water depth information. Since the water pressure is proportional to the water depth, the control unit 116 calculates the water depth information by multiplying the water pressure information by a constant. The control unit 116 selects the constant to be used in the calculation appropriately from constants stored in a data table in the memory 117.

In step S205, the control unit 116 generates the moving image data by performing the above-described procedure. The control unit 116 then attaches to each frame in the image data, shooting mode information and the water depth information converted in step S204 as the metadata, and records the resulting moving image data in the recording medium 115. The process thus ends.

On the other hand, in step S206, the control unit 116 stands by until detecting that the user has pressed the trigger key, i.e. the shooting start key, in the imaging apparatus 110. If the control unit 116 detects that the user has pressed the trigger key (YES in step S206), the process proceeds to step S207. In step S207, the control unit 116 generates the moving image data by performing the above-described procedure. The control unit 116 then causes the recording/reproducing signal processing unit 114 to record the generated moving image data in the recording medium 115. The process thus ends.

As described above, according to an exemplary embodiment, the imaging apparatus 110 becomes capable of recording by attaching a detection result of the water pressure sensor 101 to the moving image data, as the water depth information. If the user uses the imaging apparatus 110 to capture the images underwater without setting the imaging apparatus 110 to the underwater shooting mode, the imaging apparatus 110 may display a warning to prompt the user to switch the shooting mode.

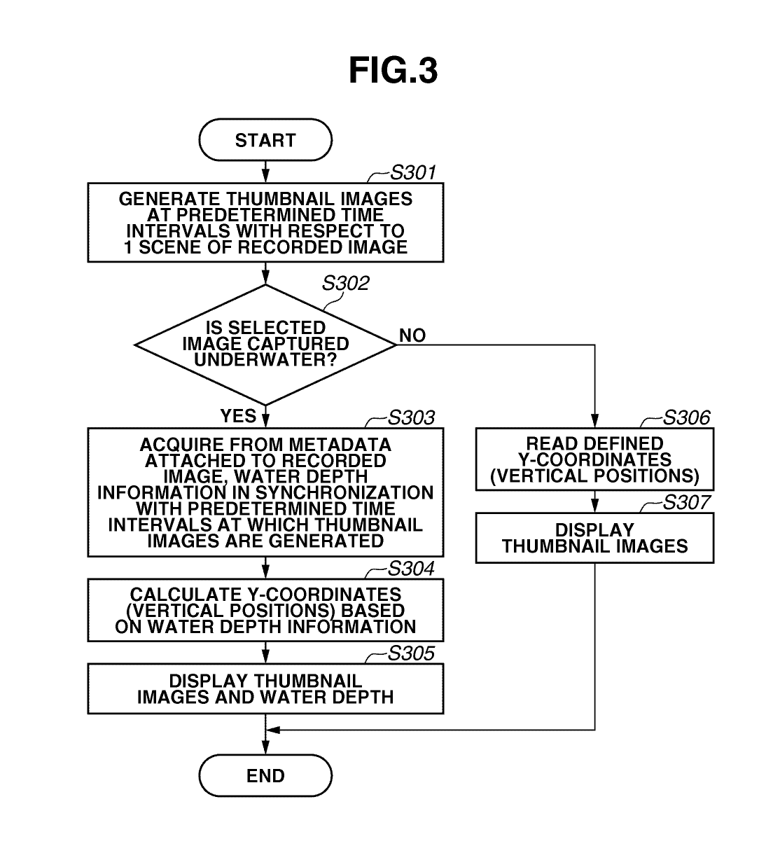

The process performed for reproducing the moving image captured by the imaging apparatus 110 will be described below with reference to the flowchart illustrated in FIG. 3. FIG. 3 is a flowchart illustrating an example process performed by the imaging apparatus 110 according to an exemplary embodiment. Each of the processes illustrated in FIG. 3 is performed under control of the control unit 116.

Further, the process for reproducing the moving image to be described below is not only performed by the imaging apparatus 110 but the process may be similarly realized by an information processing apparatus, such as a computer apparatus or a mobile communication apparatus, capable of importing the moving images from the imaging apparatus 110. In such a case, the information processing apparatus is set to the playback mode by a control unit in the apparatus which activates software, such as an operating system (OS) and a moving image reproduction application program, which a storage medium stores.

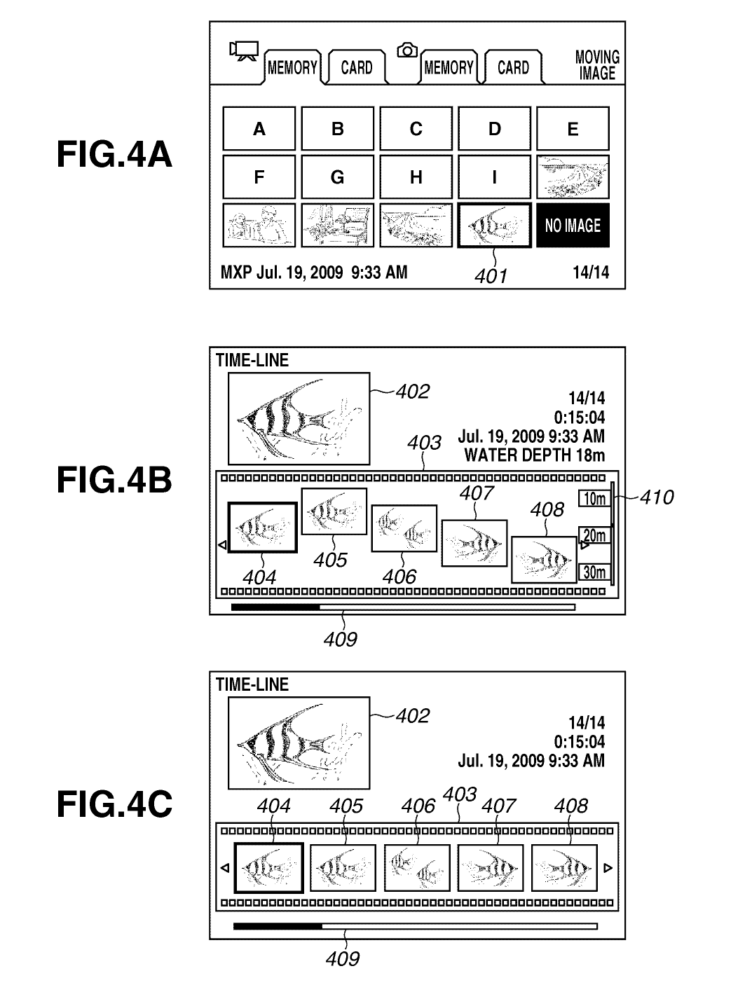

If the control unit 116 detects that the imaging apparatus 110 has been switched to the playback mode, the control unit 116 displays on the display unit 118 a screen as illustrated in FIG. 4A. Referring to the screen illustrated in FIG. 4A, a selection frame 401 is displayed surrounding a representative image of the moving image which has been last recorded. The user can select the moving image to be reproduced by operating an operation switch (not illustrated) in the main body operation unit 119. According to an exemplary embodiment, the user can select the moving image by operating the operation switch. However, the user may select the moving image by performing a touch operation on a touch panel.

The processes illustrated in FIG. 3 can be performed when the user has switched the imaging apparatus 110 to the playback mode, selected the moving image to be reproduced, and has instructed to switch the moving image in a playback standby state to a time-axis display. The process starts when the control unit 116 detects that the user has operated a key for switching the display while selecting the moving image.

When the user has selected the moving image on the screen illustrated in FIG. 4A, the control unit 116 starts the process. In step S301 illustrated in the flowchart of FIG. 3, the control unit 116 selects from a plurality of frames constituting the moving image for reproduction, the plurality of frames having been captured at predetermined time intervals, and generates thumbnail images. The control unit 116 generates the thumbnail images by reading the moving image data from the recording medium 115, decoding the read moving image data, and extracting from the decoded moving image data the frames captured at predetermined time intervals. The control unit 116 then resizes the extracted frames to the size of the thumbnail images, for example 160×120 pixels, encodes the resized frames into joint picture experts group (JPEG) data, and thus generates the thumbnail images. The predetermined time interval may be an arbitrarily set value (for example, two minutes), and may be changed to a shorter or a longer interval.

In step S302, the control unit 116 determines whether the selected moving image has been captured underwater. The control unit 116 makes the determination by confirming whether the water depth information is attached to the moving image data as metadata. If the moving image has been captured underwater (YES in step S302), the process proceeds to step S303. If the moving image has not been captured underwater (NO in step S302), the process proceeds to step S306.

In step S303, the control unit 116 acquires from among the water depth information attached to the moving image data recorded in the recording medium 115, the water depth information of predetermined time intervals synchronous with the frames corresponding to the thumbnail images generated in step S301. In step S304, the control unit 303 calculates y-coordinates or vertical positions based on the water depth information acquired in step S303.

In step S305, the control unit 116 displays on the display unit 118 the thumbnail images generated in step S301. More specifically, the control unit 116 displays the thumbnail images in a predetermined display area in the screen, arranged at the positions corresponding to the y-coordinates or vertical positions calculated in step S304. The control unit 116 also displays in the display area a scale mark indicating the water depth. The process then ends.

FIG. 4B illustrates an example of the screen displayed in step S305 of the flowchart illustrated in FIG. 3. Referring to FIG. 4B, an image 402 in the screen is an enlarged display of the representative image of the moving image which has been selected in the screen illustrated in FIG. 4A. A display area 403 displays the thumbnail images corresponding to the frames constituting the moving image in the playback standby state in chronological order, and arranged at positions based on the water depth information. More specifically, thumbnail images 404, 405, 406, 407, and 408 are generated at predetermined time intervals from the plurality of frames configuring the moving image in the playback standby state. The thumbnail images 404, 405, 406, 407, and 408 are arranged in chronological order at the positions based on the water depth information.

The moving image is divided at predetermined time intervals along a time axis. A selection cursor 409 displays an area corresponding to one scene in the moving image. A darkened portion in the selection cursor 409 indicates an area of the scene in the moving image corresponding to the currently displayed thumbnail image. The moving image has a top frame of each scene corresponding to the predetermined time interval.

If the user moves the selection cursor 409, the thumbnail images 404, 405, 406, 407, and 408 being displayed also update, so that the thumbnail images displayed on the screen change.

Scale marks 410 indicate the y-coordinates according to a scale calculated from a range of the water depth information. A water depth value based on the water depth information is displayed at the same time, so that the thumbnail images 404, 405, 406, 407, and 408 are arranged at different y-coordinate positions. In the screen illustrated in FIG. 4B, the water depth increases from an upper portion towards a lower portion of the screen, and a mark is displayed at the position corresponding to the water depth information of the selected thumbnail image.

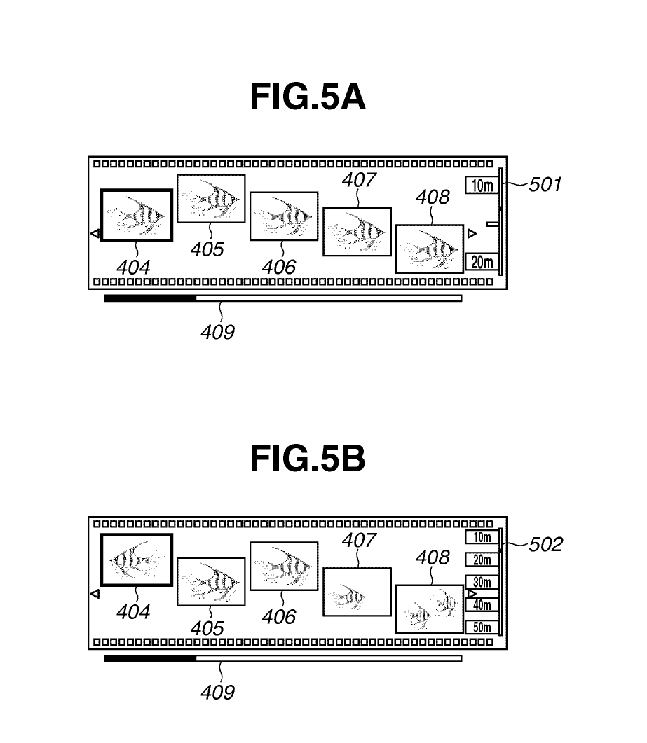

Further, a range of the water depth information differs according to a shooting condition of each moving image. A maximum value and a minimum value of the water depth are thus acquired, and a fineness of the scale of the water depth set to the display area is changed according to the range of the water depth information. FIGS. 5A and 5B illustrate display examples in which the fineness of the scale for displaying the water depth value has been changed in the display range.

FIGS. 5A and 5B illustrate the display area 403, which displays the thumbnail images in chronological order, extracted from the screen illustrated in FIG. 4B. FIG. 5A illustrates an example in which the range of the water depth information is small (e.g., 10 to 20 meters), so that the corresponding scale value of scale marks 501 and the range of the y-coordinates are small. FIG. 5B illustrates an example in which the range of the water depth information is large (e.g., 10 to 50 meters), so that the corresponding scale value of scale marks 502 and the range of the y-coordinates are large.

Returning to FIG. 3, in step S306, since the moving image has been captured normally, the control unit 116 reads from the memory 117 defined y-coordinate information. In step S307 the control unit 116 arranges, in the predetermined display area of the screen, the thumbnail images generated in step S301 at the defined y-coordinate positions read in step S306. The control unit 116 then displays the arranged thumbnail images on the display unit 118. The process then ends.

FIG. 4C illustrates an example of the screen displayed in step S307 of the flowchart illustrated in FIG. 3. Referring to FIG. 4C, the thumbnail images are displayed at the defined y-coordinate positions, so that all thumbnail images generated at predetermined time intervals are displayed at the same y-coordinate position.

As described above, according to the present exemplary embodiment, the water depth information is recorded associated with each frame of the moving image captured underwater using the imaging apparatus 110 covered by the underwater pack 100. The thumbnail images are then generated at predetermined time intervals from the moving image. Further, the y-coordinates in the display area are calculated based on the water depth information of predetermined time intervals synchronous with the generated thumbnail images. The thumbnail images are thus arranged and displayed in the display area at the calculated y-coordinate positions in chronological order. As a result, the imaging apparatus 110 becomes capable of explicitly and simply notifying a user of the change in the water depth of the moving image in the playback standby state along a time axis. The user can thus visually recognize the water depth at which the moving image has been captured, along with the change in time. Further, since the imaging apparatus 110 displays the thumbnail images arranged according to the water depth information, the user can recognize from the captured object images the approximate water depth at which organisms and plants live in. Furthermore, the user can easily recognize from the thumbnail images the time or the scene at which the object unique to each water depth has been captured.

Moreover, the displaying methods on the screen are switched according to whether the imaging apparatus 110 is set to the underwater shooting mode or a normal shooting mode. The user can thus easily recognize whether the moving image has been captured underwater or normally. For example, the user can easily identify whether the moving image has been captured by a user of the imaging apparatus diving underwater, or by shooting an aquarium from the outside in the normal shooting mode.

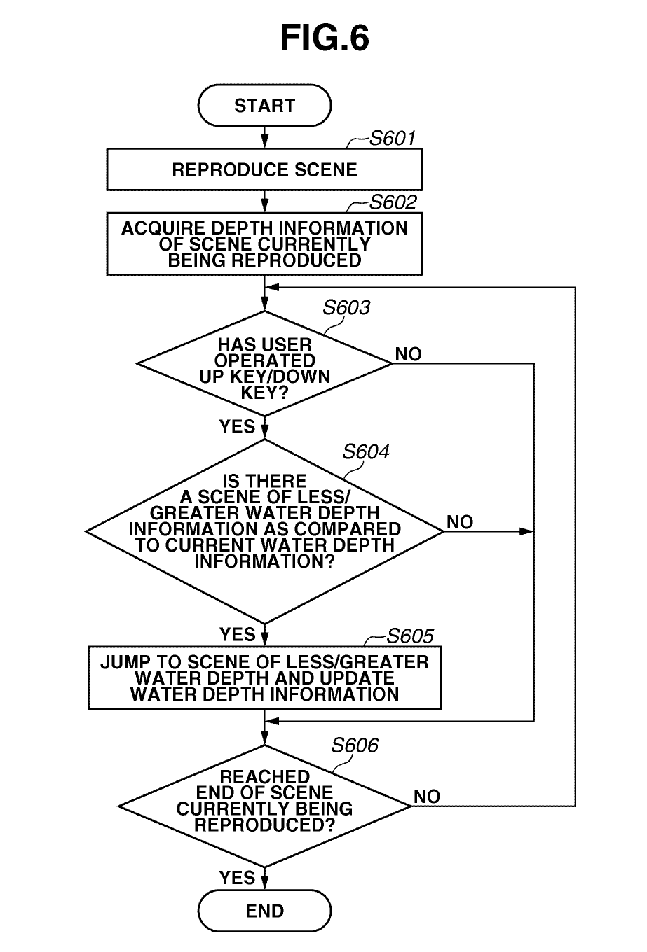

FIG. 6 is a flowchart illustrating an example of a process for reproducing the moving image. When the imaging apparatus 110 operating in the playback mode starts reproducing the moving images, the scene is switched to a scene of a different water depth according to a user operation on an up key/down key. The processes illustrated in FIG. 6 are performed by control of the control unit 116.

The control unit 116 starts the process of the flowchart illustrated in FIG. 6 when detecting that the user has pressed a playback start switch in the main body operation unit 119 while the imaging apparatus 110 is activating in the playback mode. In step S601, the imaging apparatus 110 starts reproducing the currently selected moving image. More specifically, the control unit 116 causes the recording/reproducing signal processing unit 114 to read and decode the moving image recorded in the recording medium 115, and display the moving image on the display unit 118. The control unit 116 may start reproducing the moving image from the top frame of the moving image. Further, the user may select the above-described thumbnail image, and the control unit 116 may start reproducing the moving image from the position of the frame corresponding to the selected thumbnail image. The control unit 116 thus reproduces the scene including the frame from which the control unit 116 has started reproducing.

In step S602, the control unit 116 acquires from the metadata recorded in the recording medium 115 the water depth information of the scene currently being reproduced. More specifically, the control unit 116 acquires the stored water depth information associated with the first frame of the scene in the moving image being reproduced. Further, the control unit 116 acquires the water depth information of the plurality of frames at predetermined time intervals, and the water depth information and a scene number of each scene recorded in the recording medium 115. The control unit 116 thus generates reproducing process extension information from the acquired information.

In step S603, the control unit 116 determines whether the user has pressed the up key/down key in the main body operation unit 119. If the user has pressed the up key/down key (YES in step S603), the process proceeds to step S604. If the user has not pressed the up key/down key (NO in step S603), the process proceeds to step S606.

In step S604, the control unit 116 determines whether there is a scene captured at the water depth which is less than or greater than the water depth of the scene currently being reproduced. For example, if the user has operated the up key/down key and has instructed to move upwards, the control unit 116 searches the reproducing process extension information for whether there is a scene of less water depth as compared to the current scene. On the other hand, if the user has operated the up key/down key and has instructed to move downwards, the control unit 116 searches the reproducing process extension information for whether there is a scene of greater water depth as compared to the current scene. If there is a scene of less or greater water depth (YES in step S604), the process proceeds to step S605. If there is no scene of less or greater water depth (NO in step S604), the process proceeds to step S606.

In step S605, the control unit 116 jumps to the scene captured at the water depth which is less than or greater than that of the current scene, according to the key operation in step S603. The control unit 116 then starts reproducing from the top frame of the scene. In such a case, the control unit 116 updates the water depth information of the scene currently being reproduced to the water depth information of the scene which the imaging apparatus 110 has jumped to.

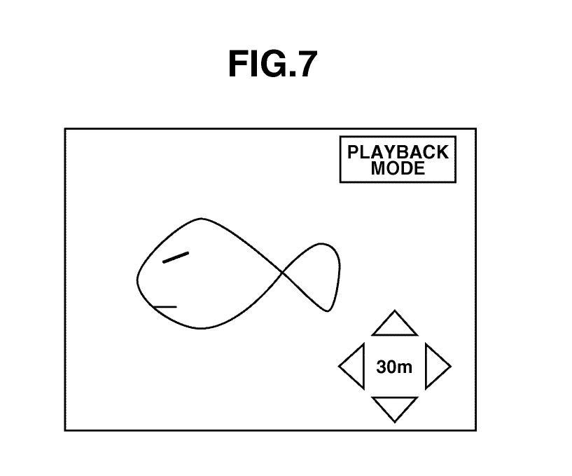

In step S606, the control unit 116 determines whether the scene currently being reproduced has reached the end. If the scene currently being reproduced has reached the end (YES in step S606), the process ends. On the other hand, if the control unit 116 is still in the process of reproducing the scene (NO in step S606), the process returns to step S603. FIG. 7 illustrates an example screen on which the scene in the moving image is displayed. In FIG. 7, the water depth information of the current scene is displayed.

As described above, according to the present exemplary embodiment, the imaging apparatus 110 can jump between scenes based on the water depth information while reproducing the moving image. As a result, the user can view the scene in the moving image captured at the water depth in which a target object image exists.

Thus, the water depth information in underwater image capturing can be used as the information indicating the shooting position with respect to the direction of gravity. Further, when the imaging apparatus 110 performs normal image capturing, a defined predetermined value is used as the altitude information. However, when normal image capturing is to be performed, the altitude may be measured and recorded, and the recorded altitude information may be used as the information indicating the shooting position with respect to the direction of gravity, similar to underwater image capturing described above. The thumbnail images may then be arranged at the positions corresponding to the altitudes.

According to a second exemplary embodiment, when the imaging apparatus 110 is in the playback standby state, the imaging apparatus 110 allows the user to visually recognize the water depth at which the moving image is captured. Further, the imaging apparatus 110 allows the user to visually recognize timing at which the imaging apparatus 110 switches between underwater image capturing and normal image capturing. Descriptions for the configurations and the processes similar to those described with respect to the first exemplary embodiment are omitted.

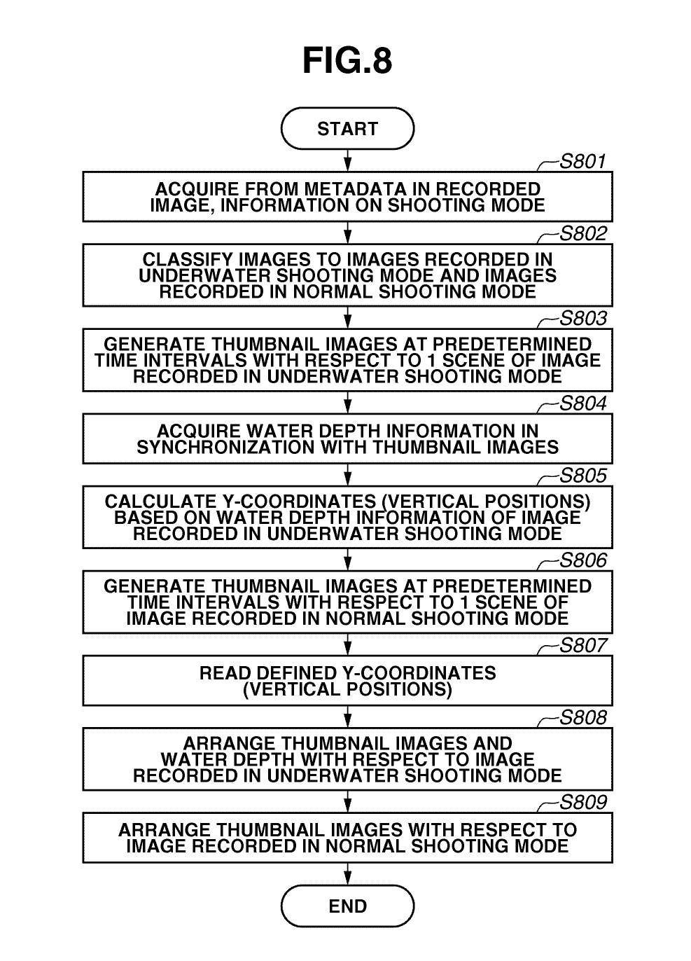

The process performed by the imaging apparatus 110 according to the second exemplary embodiment is described with reference to the flowchart illustrated in FIG. 8. The imaging apparatus 110 switches to the playback mode in response to the user operation. The user then selects the moving image to be reproduced, and the imaging apparatus 110 switches to displaying, in chronological order, the thumbnail images corresponding to the moving image in the playback standby state. The process is a routine which the control unit 116 starts when detecting that the user has operated a display switching key.

The user selects the moving image to be reproduced on the screen illustrated in FIG. 4A. In step S801 the control unit 116 acquires, from the metadata of the moving image data recorded in the recording medium 115, the information on the shooting mode set by the user. The process of step S801 is performed to classify the moving image data as the moving image captured in the normal shooting mode, and as the moving image captured in the underwater shooting mode. The normal shooting mode is the shooting mode applied when normally capturing the images above ground.

In step S802, the control unit 116 classifies the moving image based on the shooting mode information acquired in step S801. In step S803, the control unit 116 acquires the frames corresponding to predetermined time intervals in the moving image captured in the underwater shooting mode. The control unit 116 then generates the thumbnail images from the acquired frames. The method for generating the thumbnail images is similar to the method described with respect to the first exemplary embodiment.

In step S804, the control unit 116 acquires the water depth information of predetermined time intervals synchronous with the frames corresponding to the thumbnail images generated in step S803. The control unit 116 acquires such water depth information from among the water depth information attached to the moving image data recorded in the recording medium 115. In step S805, the control unit 116 calculates the y-coordinates based on the water depth information of the moving image captured in the underwater shooting mode.

In step S806, the control unit 116 generates the thumbnail images from the frames corresponding to predetermined time intervals in the moving image captured in the normal shooting mode classified in step S802. In step S807, the control unit 116 reads the defined y-coordinate information from the memory 117. The process of step S807 is performed so that the y-coordinates of the display positions of the thumbnail images are not changed for the moving image captured in the normal shooting mode, unlike for the moving image captured in the underwater shooting mode.

In step S808, the control unit 116 arranges the thumbnail images generated in step S803 in the predetermined display area in the screen, at the positions indicated by the y-coordinates calculated based on the water depth information in step S805. The control unit 116 then displays the thumbnail images on the display unit 118. In such a case, the control unit 116 adds to the display area and displays the scale marks indicating the water depths. In step S809, the control unit 116 arranges the thumbnail images generated in step S806 in the predetermined display area in the screen, at the defined y-coordinate positions read in step S807. The control unit 116 then displays the thumbnail images on the display unit 118. The process then ends.

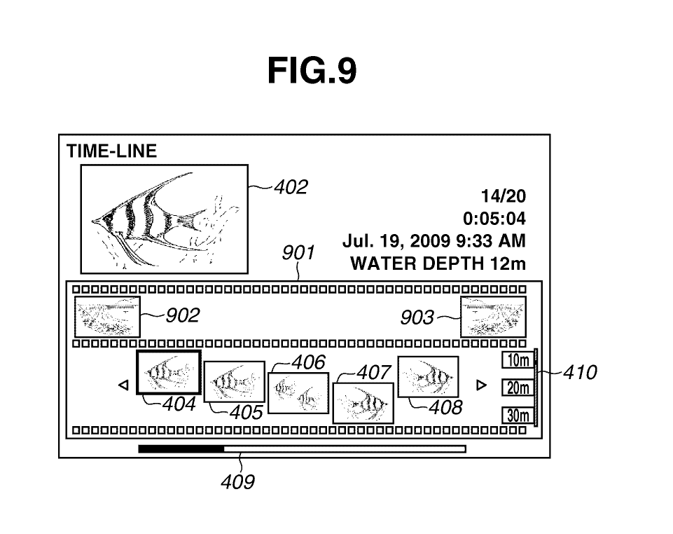

FIG. 9 illustrates an example of the screen displayed in step S809 of the flowchart illustrated in FIG. 8. Since the moving image captured underwater is displayed in chronological order, as in the first exemplary embodiment, only the differences in the second exemplary embodiment when compared to the first exemplary embodiment will be described below.

Referring to FIG. 9, the thumbnail images of the moving image captured in the normal shooting mode are displayed in the upper portion of an area 901, while the thumbnail images of the moving image captured in the underwater shooting mode are displayed in the lower portion of the area 902. Specifically, the screen displays a thumbnail image 902 generated from a last frame among the frames corresponding to predetermined time intervals of the moving image captured in the normal shooting mode. Further, the screen displays the thumbnail images 404, 405, 406, 407, and 408 generated from the moving image captured in the underwater shooting mode. Furthermore, the screen displays a thumbnail image 903 generated from a first frame among the frames corresponding to predetermined time intervals of the moving image captured in the normal shooting mode after image capturing in the underwater shooting mode has been performed.

In the example illustrated in FIG. 9, the thumbnail images corresponding to the moving image captured in the normal shooting mode are displayed in the upper portion, and the thumbnail images corresponding to the moving image captured in the under shooting mode displayed in the lower portion. However, this is not the only possible configuration. For example, zones may be set according to levels of the water depth in performing underwater image capturing. The upper portion may thus display the thumbnail images corresponding to the water depth of 10 m or less, and the lower portion may display the thumbnail images corresponding to the water depth greater than 10 m.

As described above, according to the present exemplary embodiment, the moving images captured by the imaging apparatus 110 covered by the underwater pack 100 are recorded by attaching thereto the shooting mode information and the water depth information. When the imaging apparatus 110 is then switched to the playback mode, the moving images are classified by those captured in the underwater shooting mode and the normal shooting mode. The imaging apparatus 110 generates from each of the classified moving images the thumbnail images corresponding to predetermined time intervals. Further, the imaging apparatus 110 reads the water depth information of predetermined time intervals synchronous with the thumbnail images, calculates the y-coordinates in the display area, and displays the thumbnail images in the display area in the screen, at the positions indicated by the y-coordinates.

As a result, when the imaging apparatus 110 captures the moving images in the normal shooting mode and the underwater shooting mode, the imaging apparatus 110 is capable of explicitly and simply notifying the user of the change in the water depth when performing underwater image capturing. Further, the user can visually recognize the scene in which the shooting mode has been switched from the normal shooting mode to the underwater shooting mode. Furthermore, the imaging apparatus 110 can visually notify of the scene in which the user has switched the shooting mode from the underwater shooting mode to the normal shooting mode. Moreover, the imaging apparatus 110 can provide to the user using the object image included in the thumbnail images, the approximate water depth in which the organisms and plants live.

According to a third exemplary embodiment, an example in which the thumbnail images are generated at predetermined water depth intervals from the moving image captured underwater will be described below. The descriptions relevant to the third exemplary embodiment which are similar to those already described above for the first and second exemplary embodiments will be omitted.

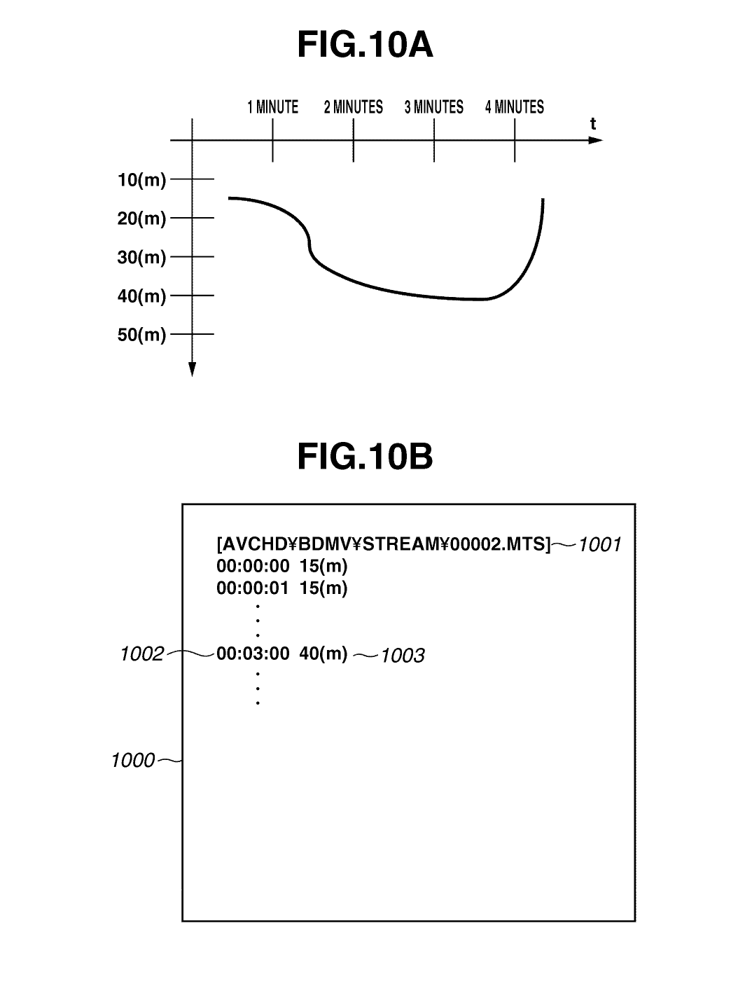

A file format of the metadata in the moving image data recorded in the recording medium 115 will be described below with reference to FIGS. 10A and 10B. FIG. 10A illustrates a change in the water depth, from start to end of capturing the moving image underwater. Referring to FIG. 10A, a time t is indicated on a horizontal axis, and a water depth 1 is indicated on a vertical axis. FIG. 10B illustrates an example of a metadata file 1000 of the water depth information in the image capturing state illustrated in FIG. 10A. A file path 1001 of the moving image, a time stamp 1002 of the moving image, and water depth information 1003 corresponding to the time stamp 1002 are described in the metadata file 1000.

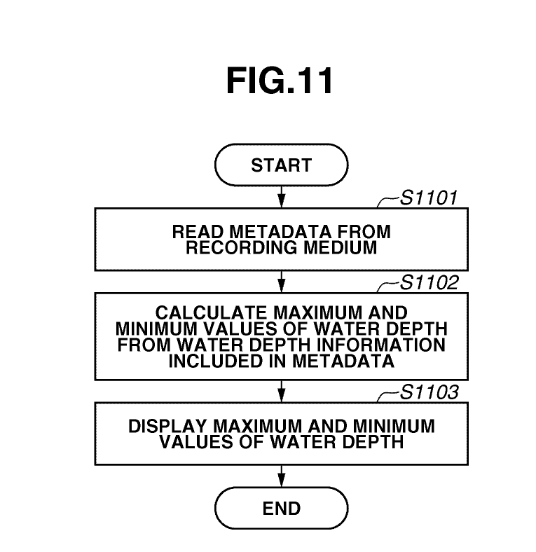

FIG. 11 is a flowchart illustrating an example of a process for displaying on the displaying unit 118 the maximum value and the minimum value of the water depth with at which the moving image is captured according to the present exemplary embodiment. Each of the processes in the flowchart illustrated in FIG. 11 is performed under control of the controlling unit 116.

When the user selects the moving image on the screen, as illustrated in FIG. 4A, the process starts. In step S1101, the control unit 116 reads the metadata of the selected moving image from the recording medium 115. In step S1102, the control unit 116 analyzes the water depth information included as the metadata, and acquires the maximum value and the minimum value of the water depth.

In step S1103, the control unit 116 displays on the display unit 118 the maximum value and the minimum value of the water depth calculated in step S1102. The process then ends. For example, if the user has selected the representative image displayed in the selection frame 401 in the screen illustrated in FIG. 4A, the control unit 116 calculates the maximum value and the minimum value of the water depth from the metadata of the moving image corresponding to the representative image. The control unit 116 then displays the calculation result on the screen.

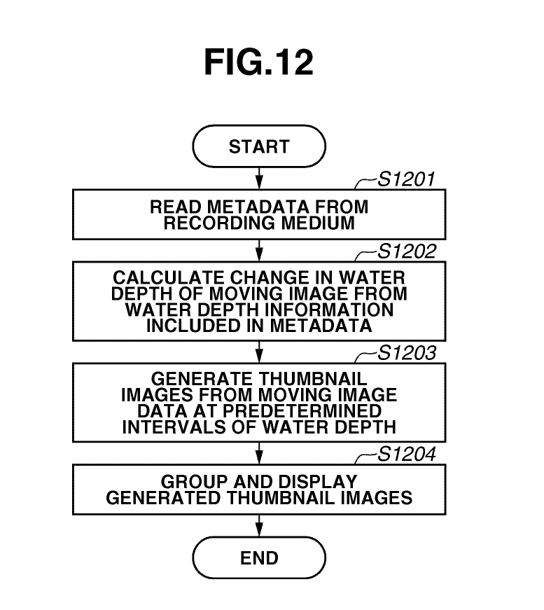

The control process performed for displaying the thumbnail images with respect to each water depth of the position at which the moving image has been captured will be described below with reference to the flowchart illustrated in FIG. 12. Each of the processes in the flowchart illustrated in FIG. 12 is performed by control of the controlling unit 116.

In step S1201, the control unit 116 reads from the recording medium 115 the metadata of the moving image. In step S1202, the control unit 116 analyzes the metadata and calculates the change in the water depth of the moving image as illustrated in FIG. 10A. In step S1203, the control unit 116 acquires from the moving image the frames captured at predetermined water depth intervals, and generates the thumbnail images from the acquired frames. In step S1204, the control unit 116 groups the plurality of thumbnail images generated at predetermined water depth intervals, according to the moving images from which the thumbnail images are generated. The control unit 116 then displays the grouped thumbnail images on the display unit 118.

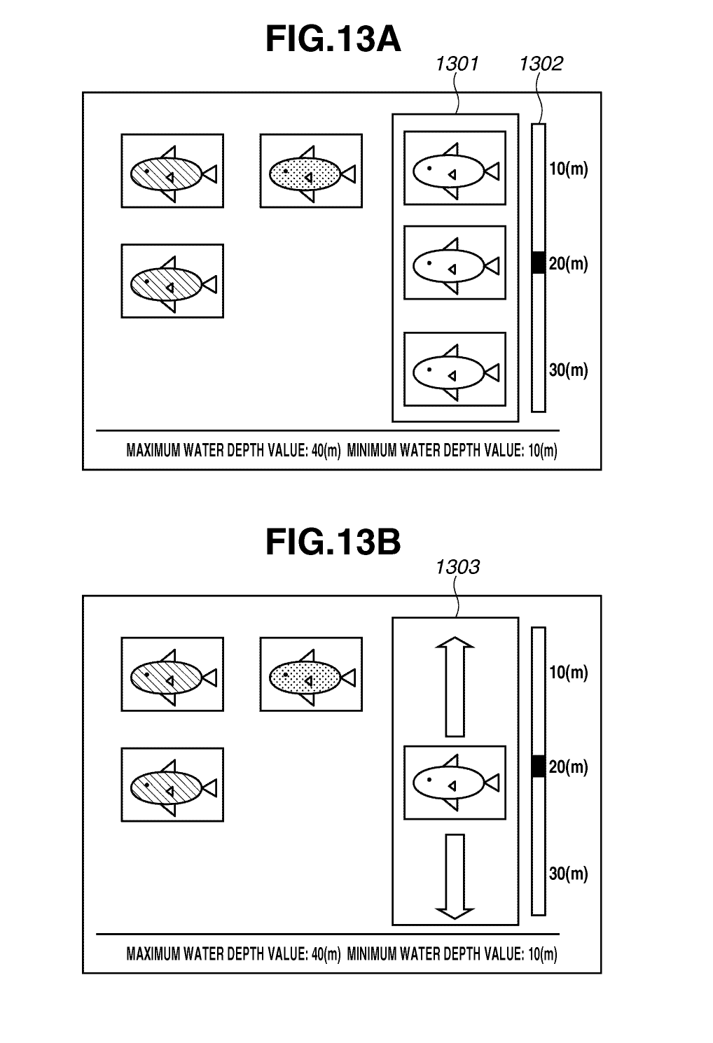

For example, if the predetermined water depth interval is 10 meters, the control unit 116 generates the thumbnail images from each of the frames constituting the moving image, captured at the water depths of 10 meters, 20 meters, and 30 meters respectively. The control unit 116 then groups the thumbnail images according to the moving image from which the thumbnail images are generated, and displays the grouped thumbnail images. A group 1301 illustrated in FIG. 13A includes the plurality of thumbnail images generated from one moving image captured at the water depths between 10 meters and 40 meters.

FIG. 13A illustrates an example of the screen displayed in step S1204 of the flowchart illustrated in FIG. 12. The screen displays, starting from the upper portion, the thumbnail images in an increasing order of the water depth level, so that the user can explicitly view the change in the water depth of the moving image. The group 1301 includes four thumbnail images generated at every 10 meters of the water depth from one moving image captured underwater at water depths between 10 meters and 40 meters. The three thumbnail images included in the group 1301 corresponding to the water depths of 10 meters to 30 meters among the range of the water depth displayed in the display area are grouped and displayed.

As described above, the imaging apparatus 110 generates the thumbnail images at predetermined water depth intervals from the moving image and displays the thumbnail images in groups. The imaging apparatus 110 is thus capable of explicitly notifying the user of the range of the water depth in which one moving image has been captured. Further, the imaging apparatus 110 displays a scroll bar 1302 in the screen illustrated in FIG. 13A to be used in changing the range of the water depth in the display area displaying the thumbnail images. Accordingly, a resolution of the scroll bar 1302 is displayed associated with the water depth, so that the imaging apparatus 110 can explicitly notify the user of the water depth of the thumbnail images being displayed, among the water depths of the entire moving image.

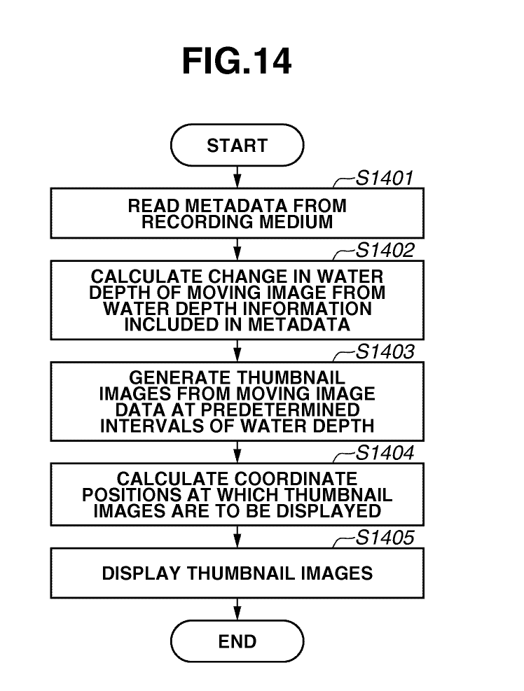

The positions for displaying the thumbnail images may also be changed according to time. The control performed for changing the positions at which the thumbnail images are displayed according to time will be described below with reference to FIG. 14. Each of the processes in the flowchart illustrated in FIG. 14 is performed by control of the controlling unit 116.

Since the processes performed in step S1401 to step S1403 are similar to those performed in step S1201 to step S1203 illustrated in FIG. 12 and described above, an additional description will be omitted.

In step S1404, the control unit 116 calculates the y-coordinates at which the thumbnail images generated from the frames captured at predetermined time intervals are to be displayed. The control unit 116 may calculate the y-coordinates from the water depths of the thumbnail images generated from the frames captured at predetermined time intervals. Further, the control unit 116 may calculate the y-coordinates from the water depths of the thumbnail images generated from the frames captured at arbitrary times, based on the change in the water depth of the moving image with respect to time. In step S1405, the control unit 116 displays at the position corresponding to the y-coordinates calculated in step S1404, the thumbnail images generated from the frame captured at the designated time.

FIG. 13B illustrates an example of the screen displayed in step S1405 illustrated in FIG. 14. Referring to FIG. 13B, the thumbnail images which are displayed and the positions at which the thumbnail images are displayed in the display area are changed according to the time the frames from which the thumbnail images are generated are captured. The area 1303 includes arrows indicating a range of the water depths where the moving image is captured, and a thumbnail image representing the moving image.

According to the present exemplary embodiment, the imaging apparatus 110 changes the thumbnail images and shifts the arrangement of the thumbnail images according to time. The imaging apparatus 110 is thus capable of explicitly notifying the user of the change in the water depth and the range of the water depth when capturing the moving image underwater.

According to the first exemplary embodiment, if the user operates the up key/down key while the imaging apparatus 110 is reproducing the moving image, the scene jumps to a scene of a different water depth. According to a fourth exemplary embodiment, if the user further operates a left key/right key while the imaging apparatus 110 is reproducing the moving image, the scene jumps to a scene of the same water depth. The descriptions corresponding to the fourth exemplary embodiment which are similar to those already provided above with respect to the first, second, or third exemplary embodiments will be omitted.

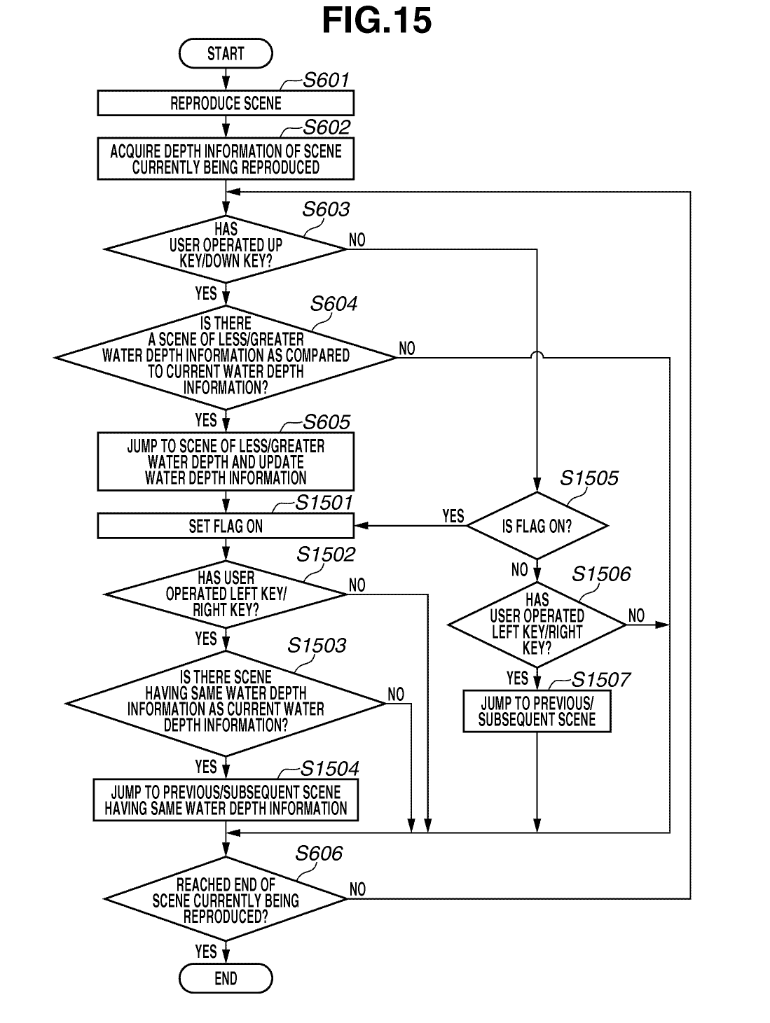

FIG. 15 is a flowchart illustrating an example of a process. When the imaging apparatus 110 is operating in the playback mode and then starts to reproduce the moving image, the scene jumps to the scene of a different water depth or the same water depth according to the user operating the up key/down key or the left key/right key. Each of the processes in the flowchart illustrated in FIG. 15 is performed by control of the controlling unit 116. Further, since the processes performed in step S601 to step S606 are the same as those illustrated in FIG. 6, detailed description will be omitted. However, according to the fourth exemplary embodiment, if the control unit 116 determines in step S603 that the user has not operated the up key/down key (NO in step S603), the process proceeds to step S1505.

In step S1501, the control unit 116 sets a flag indicating that the scene corresponding to the water depth information designated by the user operating the up key/down key in step S605 is being reproduced. In step S1502, the control unit 116 determines whether the user has operated the left key/right key. If the user has operated the left key/right key (YES in step S1502), the process proceeds to step S1503. If the user has not operated the left key/right key (NO in step S1502), the process proceeds to step S606.

In step S1503, the control unit 116 determines whether there are other scenes having the same water depth information as the water depth information of the scene currently being reproduced. The control unit 116 determines by searching the reproducing process extension information. If there are other scenes having the same water depth information (YES in step S1503), the process proceeds to step S1504. On the other hand, if there is no other scene having the same water depth information (NO in step S1503), the process proceeds to step S606.

In step S1504, the control unit 116 causes the scene to jump to the scene having the same water depth information, according to a direction in which the user has operated the left key/right key in step S1502. The control unit 116 then starts reproducing the scene from the top frame of the scene. In other words, if the user operates the left key/right key towards a right side, the scene jumps to the scene of a greater scene number and of the same water depth information as the scene currently being reproduced. In contrast, if the user operates the left key/right key towards a left side, the scene jumps to the scene of a smaller scene number and the same water depth information as the scene currently being reproduced.

In step S1505, the control unit 116 determines whether the flag is ON. If the flag is ON (YES in step S1505), the process proceeds to step S1501. If the flag is OFF (NO in step S1505), the process proceeds to step S1506.

In step S1506, the control unit 116 determines whether the user has operated the left key/right key. If the user has operated the left key/right key (YES in step S1506), the process proceeds to step S1507. If the user has not operated the left key/right key (NO in step S1506), the process proceeds to step S606.

In step S1507, if the user has operated the left key/right key towards the right side, the scene jumps to the scene of a greater scene number as compared to the scene currently being reproduced. If the user has operated the left key/right key towards the left side, the scene jumps to the scene of a smaller scene number as compared to the scene currently being reproduced.

According to the present exemplary embodiment, the user can easily confirm the scene which has been captured at the same water depth at a different time.

According to a fifth exemplary embodiment, if the user operates the left key/right key while the imaging apparatus 110 is reproducing the moving image, the imaging apparatus 110 selectively decides whether to jump to the scene of the same water depth or to the next scene regardless of the water depth. The descriptions corresponding to the fifth exemplary embodiment which are similar to those already provided above for the first, second, third, or fourth exemplary embodiments will be omitted.

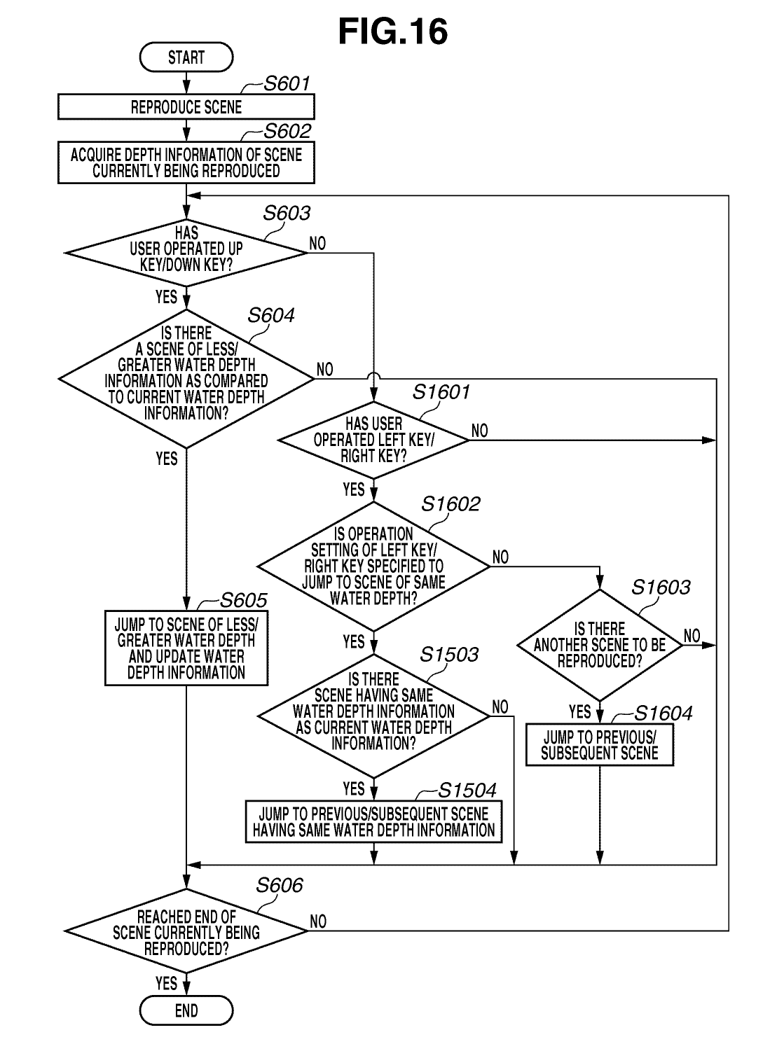

FIG. 16 is a flowchart illustrating an example of the process. When the imaging apparatus 110 is operating in the playback mode and then starts to reproduce the moving image, the imaging apparatus 110 switches the scene to be reproduced according to the user operation on the up key/down key or the left key/right key. Each of the processes in the flowchart illustrated in FIG. 16 is performed by control of the controlling unit 116. Further, since the processes performed in step S601 to step S606 are the same as those illustrated in FIG. 6, and step S1503 and step S1504 are the same as those illustrated in FIG. 15, a separate detailed description will be omitted.

In step S1601, the control unit 116 determines while reproducing an arbitrary scene, whether the user has operated the left key/right key. If the user has operated the left key/right key (YES in step S1601), the process proceeds to step S1602. If the user has not operated the left key/right key (NO in step S1601), the process proceeds to step S606.

In step S1602, the control unit 116 acquires operation setting information of the left key/right key in the playback mode which has been preset by the user. The control unit 116 then determines the operation setting of the left key/right key. The operation setting information is generated by the displaying unit 118 displaying a setting menu, and the user selecting a predetermined item on the setting menu. The user can select on the setting menu, “jump to normal scene” or “jump to scene of same water depth” as the operation to be performed by the left key/right key.

If the user has selected “jump to normal scene”, and the user operates the left key/right key, the scene jumps to the scene of the scene number immediately before or immediately after the scene number of the current scene. On the other hand, if the user has selected “jump to scene of same water depth”, the scene jumps to the scene of a scene number closest to that of the current scene among the scenes having the same water depth information as the current scene. If the operation setting information indicates “normally increment scene number” (NO in step S1602), the process proceeds to step S1603. If the operation setting information indicates “jump to scene of same water depth” (YES in step S1602), the process proceeds to step S1503.

In step S1603, the control unit 116 determines whether there is a subsequent scene to be reproduced according to the user operation on the left key/right key. If there is a subsequent scene to be reproduced (YES in step S1603), the process proceeds to step S1604. If there is no subsequent scene to be reproduced (NO in step S1603), the process proceeds to step S606.

In step S1604, the control unit 116 causes, if the user has operated the left key/right key towards the right side in step S1601, the scene to jump to the scene whose scene number is larger than that of the scene currently being reproduced. If the user has operated the left key/right key towards the left side in step S1601, the control unit 116 causes the scene to jump to the scene whose scene number is smaller than that of the scene currently being reproduced.

According to the present exemplary embodiment, if the user instructs the imaging apparatus 110 to jump from the scene in the moving image currently being reproduced, the imaging apparatus 110 selectively reproduces the scene according to the intention of the user as follows. The imaging apparatus 110 switches to another scene of the same water depth, or to another scene regardless of the water depth, and reproduces the scene. User friendliness is thus improved.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions. Further, portions of the above-described exemplary embodiments may be combined as appropriate.

This application claims priority from Japanese Patent Application No. 2011-139628 filed Jun. 23, 2011, which is hereby incorporated by reference in its entirety.

What is claimed is:

1. An image processing apparatus comprising:
a generation unit configured to generate thumbnail images from frames included in a moving image; and
a display unit configured to arrange and display the thumbnail images based on shooting time and shooting position, with respect to a direction of gravity, of the frames corresponding to the thumbnail images,
wherein the generation unit generates the thumbnail images from the frames captured at each of a plurality of predetermined levels in the direction of gravity.

2. The image processing apparatus according to claim 1,
wherein the display unit displays the generated thumbnail images by grouping the thumbnail images according to the moving image from which the thumbnail images are generated.

3. The image processing apparatus according to claim 1,
wherein in a case where the moving image is captured underwater, the display unit performs the display process, and the shooting position with respect to the direction of gravity corresponds to water depth.

4. The image processing apparatus according to claim 1, further comprising:
an acquisition unit configured to acquire a maximum value and a minimum value of the shooting positions of the thumbnail images with respect to the direction of gravity,
wherein the display unit displays the thumbnail images in a display area including a scale based on the acquired maximum value and minimum value.

5. The image processing apparatus according to claim 1, further comprising:
a selection unit configured to select at least one thumbnail image from the displayed thumbnail images; and
a reproducing unit configured to start reproducing the moving image from the frame corresponding to the at least one selected thumbnail image.

6. The image processing apparatus according to claim 1, further comprising:
a selection unit configured to select a thumbnail image from the displayed thumbnail images according to the shooting position with respect to the direction of gravity; and
a reproducing unit configured to start reproducing the moving image from the frame corresponding to the selected thumbnail image.

7. The image processing apparatus according to claim 1, further comprising:
a recording unit configured to acquire a frame from a camera signal acquired by capturing an object image, and record the frame; and
a detection unit configured to detect, while capturing the object image, information on the shooting position with respect to the direction of gravity,
wherein the recording unit records, in association with the frame, the detected information on the shooting position with respect to the direction of gravity.

8. An image processing apparatus comprising:
a generation unit configured to generate thumbnail images from frames included in a moving image; and
a display unit configured to arrange and display the thumbnail images based on shooting time and shooting position with respect to a direction of gravity of the frames corresponding to the thumbnail images,
wherein the generation unit generates the thumbnail images from the frames captured at a plurality of predetermined time intervals.

9. The image processing apparatus according to claim 8,
wherein in a case where the moving image is captured underwater, the display unit performs the display process, and the shooting position with respect to the direction of gravity corresponds to water depth.

10. The image processing apparatus according to claim 8, further comprising:
an acquisition unit configured to acquire a maximum value and a minimum value of the shooting positions of the thumbnail images with respect to the direction of gravity,
wherein the display unit displays the thumbnail images in a display area which includes a scale based on the acquired maximum value and minimum value.

11. The apparatus according to claim 8, further comprising:
a selection unit configured to select at least one thumbnail image from the displayed thumbnail images; and
a reproducing unit configured to start reproducing the moving image from the frame corresponding to the at least one selected thumbnail image.

12. The image processing apparatus according to claim 8, further comprising:
a selection unit configured to select a thumbnail image from the displayed thumbnail images according to the shooting position with respect to the direction of gravity; and
a reproducing unit configured to start reproducing the moving image from the frame corresponding to the selected thumbnail image.

13. The image processing apparatus according to claim 8, further comprising:
a recording unit configured to acquire a frame from a video signal acquired by capturing an object image, and record the acquired frame; and
a detection unit configured to detect, while capturing the object image, information on the shooting position with respect to the direction of gravity,
wherein the recording unit records, in association with the frame, the detected information on the shooting position with respect to the direction of gravity.

14. An image processing method comprising:
generating thumbnail images from frames captured at each of a plurality of predetermined levels in the direction of gravity, from among the frames included in a moving image; and
arranging and displaying the thumbnail images based on shooting time and shooting position of the thumbnail images, with respect to a direction of gravity of the frames corresponding to the thumbnail images.

15. An image processing method comprising:
generating thumbnail images from frames captured at predetermined time intervals among the frames included in a moving image; and
arranging and displaying the thumbnail images based on shooting time and shooting position, with respect to a direction of gravity of the frames corresponding to the thumbnail images.

16. A non-transitory computer-readable storage medium storing a program causing a computer to perform an image processing method comprising:
generating thumbnail images from a plurality of frames captured at each of a plurality of predetermined levels in the direction of gravity among the frames included in a moving image; and
arranging and displaying the thumbnail images based on shooting time and shooting position, with respect to a direction of gravity of the frames corresponding to the thumbnail images.

17. A non-transitory computer-readable storage medium storing a program causing a computer to perform an image processing method comprising:
generating thumbnail images from a plurality of frames captured at a plurality of predetermined time intervals among the frames included in a moving image; and
arranging and displaying the thumbnail images based on shooting time and shooting position, with respect to a direction of gravity of the frames corresponding to the thumbnail images.
